(19) United States
(12) Patent Application Publication
(10) Pub. No.: US 2015/0053317 A1
(43) Pub. Date: Feb. 26, 2015

(54) OBJECT PROTECTION DEVICE

(71) Applicant: Shi Hoo FAN, Kowloon (HK)

(72) Inventor: Shi Hoo FAN, Kowloon (HK)

(21) Appl. No.: 13/973,625

(22) Filed: Aug. 22, 2013

(51) Int. Cl. A47C 31/00; A47C 31/10; A47C 31/11; A01M 1/20

(52) U.S. Cl. CPC A47C 31/007; A01M 1/20; A47C 31/105; A47C 31/11
USPC 150/158; 53/469

(57) ABSTRACT

An apparatus for enveloping an object that is susceptible to infestation by insects, such as bed bugs, includes a pre-sized object encasement device equipped with selectively engaged sealing devices to prevent insects from infesting the object. The apparatus further employs a plurality of barriers to augment the selectively engaged sealing device to prevent insects that have already infested the object from exiting the object through any potential openings in the selectively engageable sealing device.

### BACKGROUND OF THE INVENTION

1. Field of the Invention

The present invention relates to an apparatus and method for preventing infestation of an object by insects and other pests. More particularly, the invention relates to an enclosure structure or encasement secured around a mattress or seat cushion which, while allowing for the removal of the mattress or seat cushion from the encasement, prevents the egress and ingress of bed bugs.

2. Discussion of the Related Art

Insects of the genus Cimex, e.g., bed bugs, and other insects commonly infest mattresses and other bedding materials, as well as seat cushions. They can be found in almost any type of fabric material, such as airline seats, hotel mattresses, office chairs, couches and movie theater seats. Bed bugs live on the surface and the interior of fabric that comes into frequent contact with humans. Bed bugs feed on human blood, and some can transmit illness. As such, one of the most infested articles is the one where humans spend a significant amount of time, namely their mattresses. Thus, it is imperative to prevent bed bugs from colonizing bedding or seating items. This is because once such an item, such as a mattress, has been infested with bed bugs, it becomes unsuitable for resale or even general use. Even if successfully purged of the infestation, it is likely that the resale value will be limited.

To prevent entry of bed bugs into a mattress various techniques and approaches have been tried in the past with varying levels of success. The prior art is filled with examples of mattress protection devices configured to prevent the movement of insects. Each of these prior art techniques have inherent drawbacks. For example, where mattress encasement devices rely on zipper driven enclosures, the zipper may become partially unzipped through movement of the mattress. Thus, bed bugs can be released from the mattress to infest other items or introduced into the mattress. Other prior art articles and devices have attempted to overcome this drawback by providing rigidly secured flaps and straps that seek to cover the ends of the zipper tracks. However, no complete solution exists in the prior art.

U.S. Pat. No. 7,552,489 to Bell describes a mattress encasement designed to channel and trap bed bugs once they have infested a mattress. The disclosure, while providing an inherent barrier to some insects (e.g. large insects), fails to prevent the mattress from becoming infested. It merely prevents bed bugs from escaping an infested mattress.

Thus, what is needed is a protection device that prevents insects from entering or leaving an item of bedding or a seat cushion. Accordingly, there exists a need to prevent bed bugs or other insects from infesting an object when that object has been inserted into a covering.

### SUMMARY OF THE INVENTION

The present device is directed an apparatus for repelling or preventing insects from entering or infesting an article. More specifically, the present device provides an article protector using selectively engaged barriers to ensure that insects are prevented from entering or leaving through the opening of the article encasement, especially a zippered opening. In a particular aspect of the present invention, the insect repelling barriers are secured to form a channel about a zippered opening that directs insects away from the potential points of entry into the article protector. These barriers are configured to maintain a nearly continuous flat sheet surface, while at the same time having flexibility to be selectively engaged.

### BRIEF DESCRIPTION OF THE DRAWINGS

The foregoing and other features of the present invention will be more readily apparent from the following detailed description and drawings of illustrative embodiments of the invention in which:

FIG. 1 is an illustrative top left side perspective view of an embodiment of the invention;

FIG. 2 is an enlarged schematic side view of the embodiment of the invention shown in FIG. 1;

FIG. 3 is an enlarged top perspective view of the embodiment of the invention; and

FIG. 4 is a side view of an embodiment of the invention.

### DETAILED DESCRIPTION OF THE INVENTION

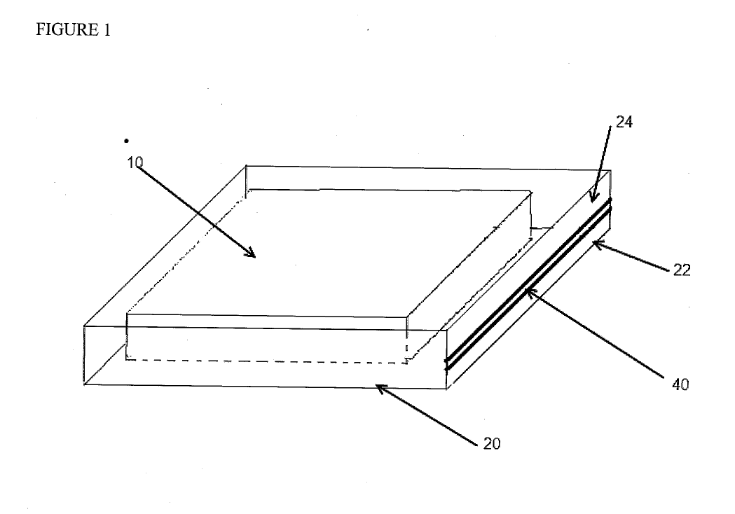

By way of overview and introduction, the present invention concerns an apparatus for enveloping an object that is susceptible to infestation by insects, such as bed bugs. As depicted in FIG. 1, a suitable application of the present invention is to enclose a mattress. Alternatively, seat cushions, pillows, furniture, and other fabric containing objects are suitable applications of the present invention. The invention, as depicted in FIG. 1, is pre-sized for a specific article (e.g. a mattress). In an alternative embodiment, the device is sized to accommodate a range of article sizes so long as they fit within the enclosure. The enclosure also is equipped with a selectively engaged sealing device to prevent insects from infesting the object. The apparatus is further directed to employing a barrier to augment the selectively engaged sealing device to prevent insects that have already infested the object from exiting the object through any potential openings in the selectively engageable sealing device.

As seen in FIG. 1, the illustrated device is a configurable material covering 20 adapted to enclose a given volume in which a object 10 is located. In the illustrated arrangement, the material covering is adapted to cover a standard mattress. In an alternative arrangement, the material covering 20 is adapted to cover an irregularly shaped object, such as a pillow, linen stack, or cushion. The material covering 20 is formed of any workable or flexible material that is impervious to insects. By way of non-limiting example, the material covering in the illustrated arrangement is formed of a natural fabric such as cotton. In the alternative, the material covering is formed of natural or synthetic fibers, woven metallic fibers, composite panels, plastic sheeting or other materials sufficient to present an impermeable barrier to an insect.

In an alternative arrangement, the material covering is impregnated with an anti-pest substance formed of at least a pesticide, insect repellant, anti-microbial compound or anti-viral substance. In particular, the anti-pest substance can be impregnated into the inner surface or interior of the material covering. For example, fibers forming the weave of the material sheet can, if applicable, be coated with an anti pest substance prior to formation of the material covering. In an alternative arrangement, anti-pest substance is sprayed or deposited on the material covering 20 prior to use. For example, silver compounds can be either impregnated into the threads forming the material covering 20 prior to its construction or the compound can be applied at a later manufacturing step.

The material covering 20 is formed so as to completely enclose an article 10. By way of non limiting example, the material covering is configured to encapsulate a standard mattress. The material covering 20 is equipped with a sealable opening 40 located within one of the surfaces of the material covering. The opening 40 is configured to allow the insertion or removal of the article 10 into the interior volume of the material covering. In the illustrated embodiment, the opening 40 is formed in the material covering 20 and is a bordered by at least two end portions of the material covering 22, 24. The two end portions of the material opening 22, 24 are configured to be any size or shape necessary to admit entry of the object 10. In an alternative arrangement, the opening is oval, circular or irregular in shape.

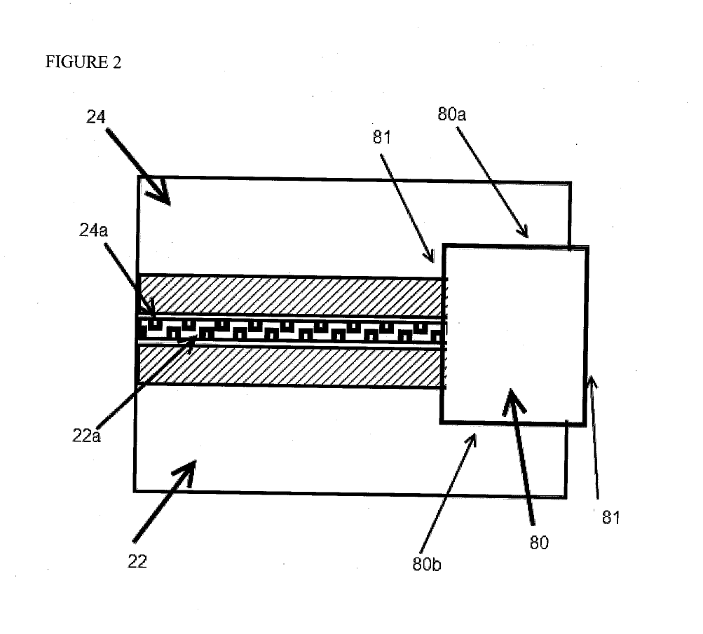

The ends portions 22, 24 of the material covering 20 are joined together to seal the opening 40. The end portions 22, 24 are configured such that when joined together with sealing elements or devices, that the opening is fully closed. As illustrated in FIG. 2, the ends portions are equipped with complementary zipper tracks 22a 24a as the sealing elements. The zipper tracks allow the zipper head 50 (not shown) of the zipper 51 to join the zipper tracks together. The zipper tracks 22a, 24a are joined to the end portions of the material covering end portions 22, 24. The zipper tracks 22a 24a in the illustrated embodiment are joined to the material covering 20 by stitching. In an alternative arrangement, the zipper tracks 22a 24a are joined to the material covering 20 by way of an adhesive. The use of a bonding or tight stitching agent to join the sealing elements to the material covering 20 is designed to prevent the passage of insects between the material covering 20 and the zipper tracks 22a, 24a. Those skilled in the art will appreciate additional bonding techniques that offer the same sealing properties.

In the illustrated arrangement, the sealing elements 22a, 24a are zipper style fasteners configured to enable the two ends 22, 24 of the opening 40 to be joined. In a differing embodiment, the end portions 22, 24 are each equipped with a magnetic, or weak adhesive coating that allows for the two end portions to be joined in such a state that insects cannot enter or exit the interior volume through the opening 40.

As seen in FIG. 2, the end portions 22, 24 once joined, form a seal that prevents insects from entering the interior of material covering 20. However, at the location of the zipper head (not shown) there can be an opening along the zipper track through which bed bugs can pass. In order to overcome this problem, a first barrier 80 is positioned between a portion of the sealed opening 40 where the zipper head would be when the zipper is closed and the article 10 placed inside the material covering 20. The first barrier 80 is formed of a material that is impermeable to insects. By way of non-limiting example, the first barrier is constructed of the same material as the material covering 20. However, in an alternative arrangement, the first barrier 80 is formed of an impermeable sheet such as plastic, carbon fiber, metal, woven metallic fibers or other similar sheeting. In a still further alternative arrangement, the first barrier 80 is formed as a single piece of material that is co-extensive with the material covering 20. For example, the first barrier is formed by taking a length of material that forms one of the sides of the material covering and looping the material to form a tab. At the apex of the loop a securing mechanism is affixed and thus the loop is configured to operate as the barrier herein described.

As seen in FIG. 2, the first barrier is rectangular in shape, having a top portion 80a, a bottom portion 80b and two parallel side portions 81. The top portion of the first barrier 80 is secured to the inside surface of the material sheeting 20 by way of an adhesive or by stitching. Additionally, at least one of the side portions 81 is affixed to the interior surface of the material covering 20.

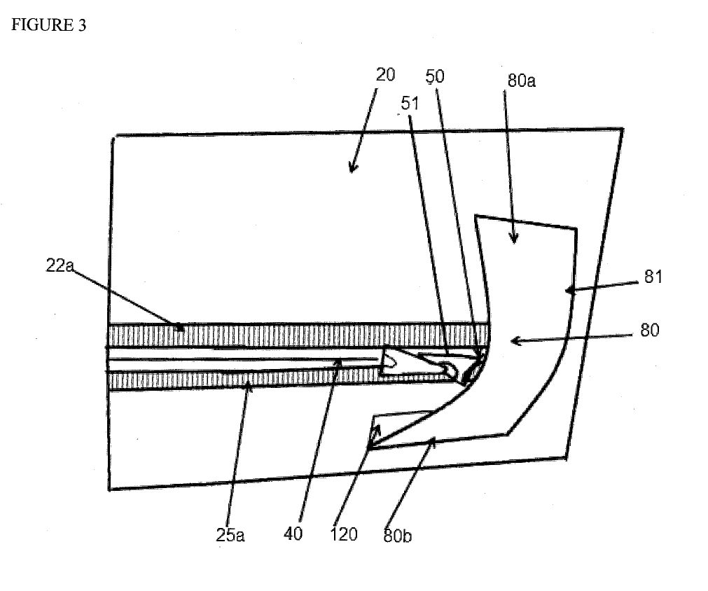

As shown in FIG. 3, the bottom portion 80b of the first barrier 80 is configured to be selectively secured to the interior surface of the material covering by a securing device or mechanism 120. When the selectively engaged portion 80b of the first barrier is engaged and joined to the material covering 20, an impermeable barrier is created that prevents insects from entering the interior volume of the apparatus.

As shown in FIG. 3, the side portion 81 is affixed to the material covering 20 such that its length spans the opening 40 when the opening is in the sealed configuration. The bottom portion 80b is secured to the interior surface of the covering material 20 by a securing mechanism 120. In the illustrated embodiment, the securing mechanism 120 is part of a hook and loop conjugate system, such as Velcro®. As shown, the hook and loop element allows the barrier to be secured along a length of the sealed opening. The bottom portion of the barrier 80b when sealed and combined with the affixed top 80a and side portion 81, forms a channel that prevents access to the zipper head area 50. Thus, the arrangement prevents the ingress or egress of insects into the interior volume of the material covering.

In the illustrated embodiments the material covering 20 and the first barrier 80 is formed of the same material. In alternative arrangements, the first barrier 80 is formed of any material that is suitable for use as an insect impermeable barrier. For example, the first barrier 80 can be selected from natural or synthetic fabrics or other materials that are sufficiently configured so as to deter insects from attempting to pass through. The first barrier 80, in a particular arrangement, is coated with pesticides or insect repellant. The pesticides or insect repellant can be selected from those pesticides used to treat or impregnate the material covering 20.

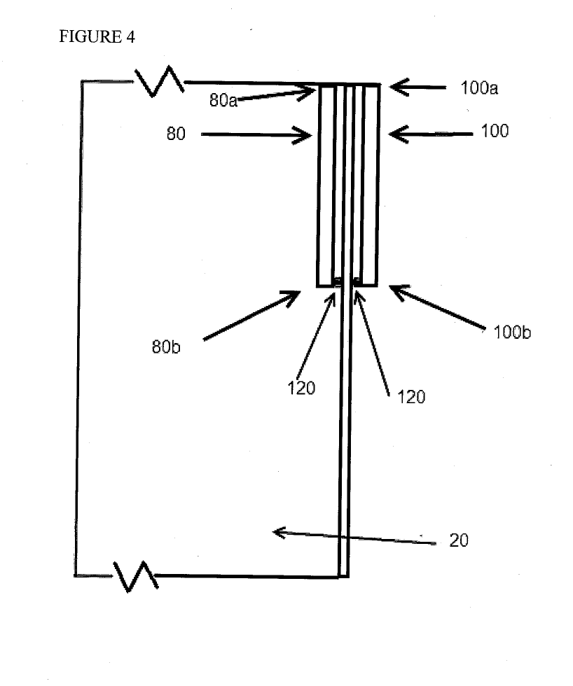

As seen in FIG. 4, a second barrier 100 can be positioned on the opposite side of the opening 40 from the first barrier 80, so that infesting pests are unable to enter the zipper track (22a, 24a are not visible in this orientation) from the outside. The second barrier 100 is formed of the same material as the first barrier 80 and functions in a similar manner. In an alternative arrangement, the second barrier 100 is of a different shape and formed of a different material than that of the first barrier 80. Similar to the first barrier 80, the second barrier 100 is configured with a top end 100a and a side end (not visible) that are secured to the material covering and a bottom end 100b that is equipped with a securing mechanism 120 configured to be removably attached to the bottom portion of the inner surface of the material covering 20. In the illustrated embodiment the bottom portion 100b of the second barrier 100 and the bottom portion 80b of the first barrier 80 are both configured to span the opening when the device is sealed.

The top portions of the first and second barriers (80a, 100a) are attached to the material covering 20 by means of stitching or an adhesive at the top portion of the zipper track. The top portions of the first and second barriers are configured to span the top part of the zipper track and form a tight, impenetrable seal that prevents access to the zipper track head 50 through the secured portion. In an embodiment of the present invention, the secured top portions are secured to the material covering by tightly stitched fabric thread. In an alternative embodiment, the secured portions are attached to the material body via thermal bonding, permanent adhesives or even a further Velcro® strip.

Each of the bottom portions of the barriers (80b, 100b) is equipped with a securing mechanism 120 designed to secure at least one side of the barrier to the material body. By securing at least two sides of the barrier (e.g. 80a, 80b) a channel or path is constructed that limits pest access to the zipper. In an alternative embodiment, the additional securing mechanisms are provided for the remaining sides of the barrier. In this configuration, an area around the opening is completely sequestered from the remainder of the material. As such, the movement of insects into and out of the volume enclosed by the material covering is restricted. Those skilled in the art will appreciate the sealing mechanism employed by the present invention. In an alternative embodiment of the present invention, each of the sides perpendicular to the top and bottom portions of the barriers (80a, 80b) are equipped with selectively engageable sealing mechanisms. In the illustrated embodiment, the two perpendicular sides are attached via Velcro® fasteners.

The present invention uses tight stitching to join the material body 20 to the first and/or second barrier in several places. Those skilled in the art will quickly appreciate those types and manner of stitching necessary to prevent migration of infesting insects. Additionally, in an alternative arrangement, the stitching is coated with pest resistant materials that ward off insects, for example silver compounds. In a particular embodiment of the present invention, the material body 20 is impregnated with chemical compounds or pesticides directed to specific insect species. In a further embodiment, the material body is coated in a thermally reflective coating that ensures that the temperature of the volume enclosed by the present invention is elevated relative to the ambient temperature.

The present invention also incorporates a methodology of using the apparatus to carry out and achieve the function of protecting an article from infestation by insects, such as bed bugs, by enclosing the article in an insect-impermeable covering. Such a method involves, but is not limited to, an insertion step, wherein the article is inserted into the material covering. A securing step is provided, wherein a barrier is secured to span the closed end position of a sealing device, such as the zipper, and provide a sealed environment. A sealing step is provided wherein the material covering is sealed such that the barrier is positioned between the sealing device and the article in question.

It should be understood that various combination, alternatives and modifications of the present invention could be devised by those skilled in the art. The present invention is intended to embrace all such alternatives, modifications and variances that fall within the scope of the appended claims.

While the invention has been particularly shown and described with reference to a preferred embodiment thereof, it will be understood by those skilled in the art that various changes in form and details may be made therein without departing from the spirit and scope of the invention.

I claim:

1. A protective casing designed to enclose an object comprising:
a flexible material having an interior surface and an exterior surface, wherein the flexible material is configured to enclose a volume of interior space, the flexible material having at least one opening for the insertion of the object into the interior space, the opening configured to be sealed selectively with a sealing mechanism and the flexible material being impermeable to pests; and
a first barrier having a top portion, a bottom portion and two side portions, said first barrier being interposed between the object and the opening, wherein the top portion of the barrier is permanently attached to the interior surface of the flexible material, and the bottom portion of the barrier is attached to the interior surface by a selectively engageable sealing device.

2. The protective casing for an object as described in claim 1, wherein a second barrier is attached to the exterior surface of the flexible material by at least one selectively engageable sealing device.

3. The protective casing for an object described in claim 1, wherein the first barrier is composed of a material that is impregnable to insects.

4. The protective casing for an object described in claim 1, wherein the first barrier and the flexible material are impregnable to insects of the insect genus Cimex.

5. The protective casing for an object described in claim 1, wherein the first barrier is impregnated with a pesticide or insect repellant substance.

6. The protective casing for an object described in claim 1, wherein at least one side portion of the first barrier is selectively attached to the interior surface of the flexible material.

7. The protective casing for an object described in claim 2, wherein at least one side portion of the first barrier is selectively attached to the interior surface of the flexible material.

8. The protective casing for an object described in claim 1, wherein at the interior surface of the flexible material is coated in heat reflective material.

9. A protective casing designed to enclose a mattress or seat cushion comprising:
a flexible material having an interior surface and an exterior surface, wherein the flexible material is configured to enclose a volume of interior space of about the size of the mattress or seat cushion, the flexible material having at least one opening for the insertion of the mattress or seat cushion into the interior space,
a zipper mechanism including a zipper head for selectively sealing the opening so that the casing is impermeable to bed bugs;
a first barrier material having a top portion, a bottom portion and two side portions, said first barrier being interposed between the mattress or cushion and the opening at the location of the zipper head when the zipper is closed to seal the opening, wherein the top portion of the barrier is permanently attached to the interior surface of the flexible material; and
a loop and hook connector attaches the bottom portion of the barrier to the interior surface, so that a channel is formed along the portion of the zipper in the region of the zipper head.

10. The protective casing of claim 9 further including a second barrier material having a a top portion, a bottom portion and two side portions, the top portion of the barrier is permanently attached to the exterior surface of the flexible material so as to be generally at a location opposite the first barrier material and the bottom of said second barrier material being attached to the exterior surface of the flexible material by at least one loop and hook connector.

11. The protective casing of claim 10 further including loop and hook connectors along the side portions of the first and second barriers.

12. A method for protecting an object with a protective casing comprising the steps of
providing an encasement device configured to enclose an object wherein the encasement device comprises:
a flexible material having an interior surface and an exterior surface, wherein the flexible material is configured to enclose a volume of interior space, the flexible material having at least one opening for the insertion of the object into the interior space, the opening configured to selectively be sealed with a sealing mechanism and the flexible material being impermeable to pests;
a first barrier having a top portion, a bottom portion and two side portions is interposed between the object and the opening, wherein the top portion of the barrier is permanently attached to the interior surface of the flexible material, and a bottom portion is the barrier is attached to the interior surface by a selectively engageable sealing device;
inserting the object into the encasement device;
securing the barrier between the sealing mechanism of the encasement device and the object and;
sealing the encasement device.
